(19) United States
(12) Patent Application Publication
(10) Pub. No.: US 2018/0099905 A1
(43) Pub. Date: Apr. 12, 2018

(54) WATERFASTNESS, SMEARFASTNESS, WEAR RESISTANCE, TOUGHNESS AND OVERALL MATERIAL DURABILITY ENHANCING NANO ADDITIVE

(71) Applicant: HK INVESTMENT PRODUCTION TRADING, Ho Chi Minh City (VN)

(72) Inventors: Nguyen C. Khe, Ho Chi Minh City (VN); Vo H. Linh, Ho Chi Minh City (VN); Dinh P. Kanh, Ho Chi Minh City (VN); Nguyen C. Hai, Ho Chi Minh City (VN); Nguyen C. Phu, Ho Chi Minh City (VN)

(73) Assignee: HK INVESTMENT PRODUCTION TRADING, Ho Chi Minh City (VN)

(21) Appl. No.: 15/291,860

(22) Filed: Oct. 12, 2016

(51) Int. Cl. C04B 24/32; C04B 14/04; C04B 24/04; C04B 24/06; C09D 11/03; C09D 11/38; C08K 3/36; C08K 5/09; C04B 28/04; H01G 11/64

(52) U.S. Cl. CPC C04B 24/32; C04B 14/04; C04B 24/04; C04B 24/06; H01G 11/64; C09D 11/38; C08K 3/36; C08K 5/09; C04B 28/04; C09D 11/03

(57) ABSTRACT

Certain exemplary embodiments can provide a durability enhancing nano additive. The nano additive can comprise a silica/acid composite. The silica/acid composite can be in a wet dispersion. The silica/acid composite can have an average particle size in the range between approximately 5 nanometers and 10 nanometers. The silica/acid composite can have an opaque or translucent white appearance.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 comprises an Fourier transform Infrared spectroscopy (“FtIR”) chart (the topmost illustrated chart) of a translucent white SC nanocomposite product of an exemplary embodiment and comparative FtIR charts (the three lower illustrated charts) for substantially pure silica;

FIG. 2 comprises an FtIR chart (the topmost illustrated chart) of a translucent white SC nanocomposite product of an exemplary embodiment and a comparative FtIR chart (the three bottommost chart) for substantially pure silica;

FIG. 3 shows an x-ray diffraction (“XRD”) chart of an exemplary SC nanocomposite;

FIG. 4 shows transmission electron microscope (“TEM”) images of an exemplary SC nanocomposite; and

FIG. 5 shows exemplary embodiments of multifunctional carboxylic acids.

### DETAILED DESCRIPTION

Certain exemplary embodiments can provide a durability enhancing nano additive. The nano additive can comprise a silica/acid composite. The silica/acid composite can be in a wet dispersion. The silica/acid composite can have an average particle size in the range between approximately five (5) nanometers and ten (10) nanometers. The silica/acid composite can have an opaque or translucent white appearance.

Certain exemplary embodiments can provide a durability enhancing nano additive. The nano additive has specific surface area (“SSA”) by Brunauer-Emmett-Teller (“BET”) measurement of approximately 443 m²/g and greater.

Certain exemplary embodiments provide a universal nano filler comprising a silica/specific multifunctional organic acid, which can be named as an “SC nanocomposite”. X-Ray Fluorescence spectroscopy (“XRF”) analysis shows Si content greater than approximately 96% by weight in the SC nanocomposite. The nano product can be compounded into a wet dispersion showing superior compatibility with a large variety of substances comprising polymers, ceramics, metals, and/or woods, etc. The universal nano filler can have an average particle size in the range approximately 5-10 nanometers (“nm”) and an opaque or translucent white appearance. Certain exemplary embodiments have a specific surface area greater than approximately 443 m²/g. This kind of silica nanocomposite can be well blended in a relatively large portion to improve the durability including mechanical reinforcement, water fastness, fast dryness for building material technology, printing material technology, energy storage technology, transportation material technology, and/or home use appliances, etc.

Certain exemplary embodiments provide nano silica materials. In a solid state, silica can have primary particles ranging from a few nanometers to several ten microns. However, some materials can be very hydrophobic, which can limit the capability of blending with other materials for certain applications.

We have been able to produce unique silica nano gel, which exhibits nano size particles with modified surfaces that enhance compatibility with different kinds of materials and be utilized in more universal additives.

Besides universal nano filler properties, the SC nanocomposite of certain exemplary embodiments can be fabricated in a relatively low cost, safe, and simple process that is promising for very large production without any significant concerns about consequences to the environment.

In an exemplary of the invention, the SC nanocomposite is made out of rice husk (“RH”), and more precisely “paddy husk” such as from rice harvested in Mekong river delta in Vietnam. The RH can be collected from a rice crop. The RH is the hard cover shell of dried original rice flower.

For our tests, the husks were dried by natural sunlight or by a heating process.

Approximately 100 grams (“g”) of the dried husk was cooked at approximately 90° C. in approximately 500 g of alkaline solution having a pH of approximately 8 for 12 hours. The aqueous solution was isolated by filtration

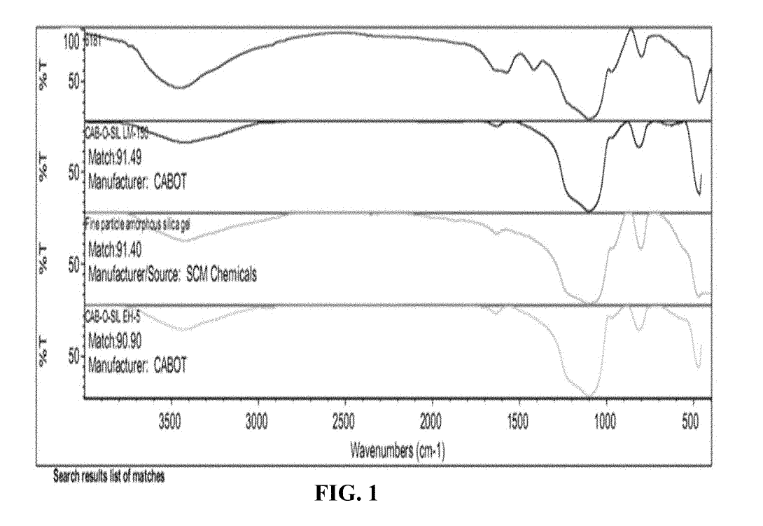

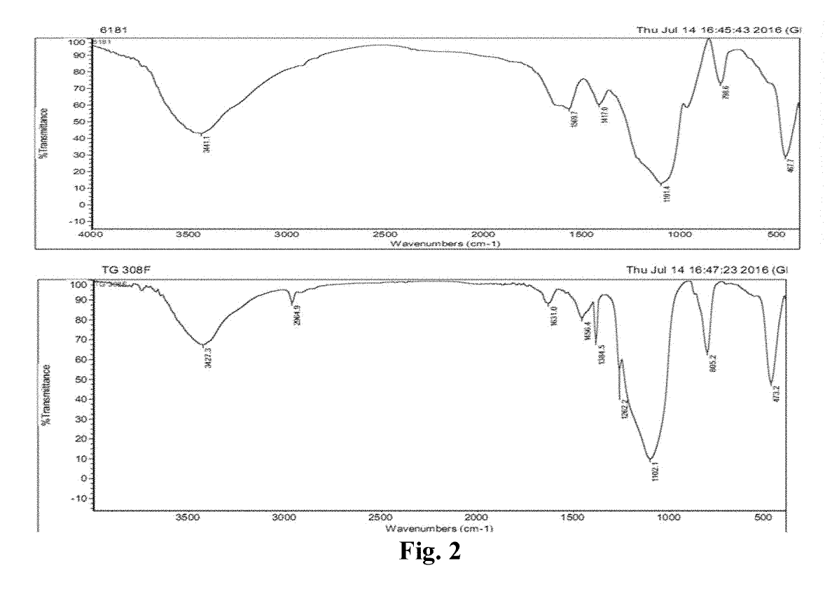

Next, the isolated clear solution was gently stirred at room temperature. Then approximately 500 g of amino benzoic acid (approximately 20% solid) was added. Right after the acidic solution was added, the silicate salt molecule left water molecule and formed translucent white suspension when the pH reached the value slightly greater than 7. The clear solution was gradually turned into translucent and stayed the same for as long as it was observed. The translucent white product stayed stable after multiple water washes without going back into solution even at a pH of approximately 7. The translucent white product was collected and ready for blending without any observed hard mixing efforts in media tested, including emulsion polymers such as latex from rubber tree, melted metals, wet ceramics, and/or wood dust, etc. FIG. 1 comprises an FtIR chart (the topmost illustrated chart) of a translucent white SC nanocomposite product of an exemplary embodiment and comparative FtIR charts (the three lower illustrated charts) for substantially pure silica. FIG. 2 comprises an FtIR chart (the topmost illustrated chart) of a translucent white SC nanocomposite product of an exemplary embodiment and a comparative FtIR chart (the three bottommost chart) for substantially pure silica. FIG. 1 and FIG. 2 show FtIR charts of translucent white product above described, which was different from that of pure silica. From the FtIR results, we determined the translucent white substance to be a composite comprising a silica core at least partially surrounded by a specific acidic shell; we named the substance “SC nanocomposite”.

The composite properties were found to be dependent on acid structure. Multifunctional carboxylic acid resulted in more translucency, which was indicative of a smaller particle size.

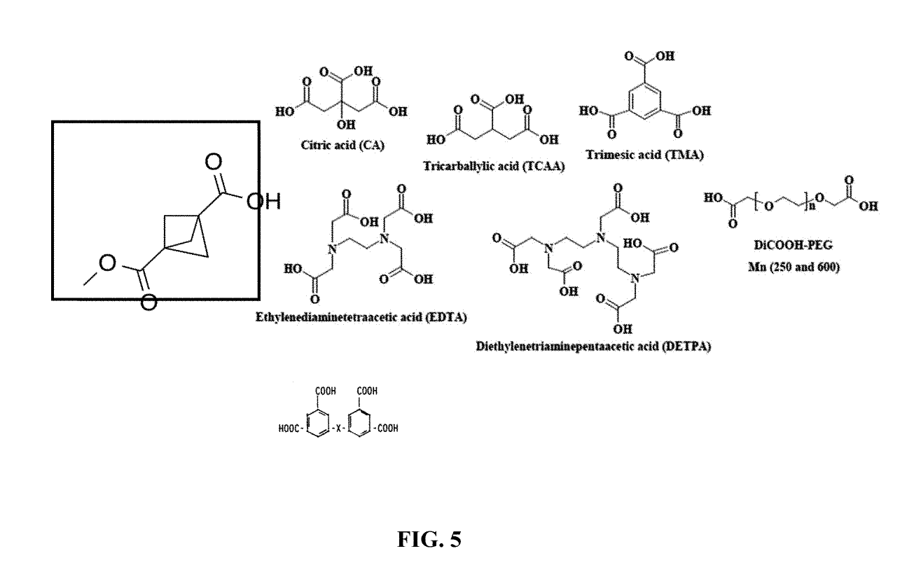

FIG. 5 shows exemplary embodiments of multifunctional carboxylic acids. Exemplary embodiments of multifunctional carboxylic acids can include, but are not limited to those illustrated in FIG. 5.

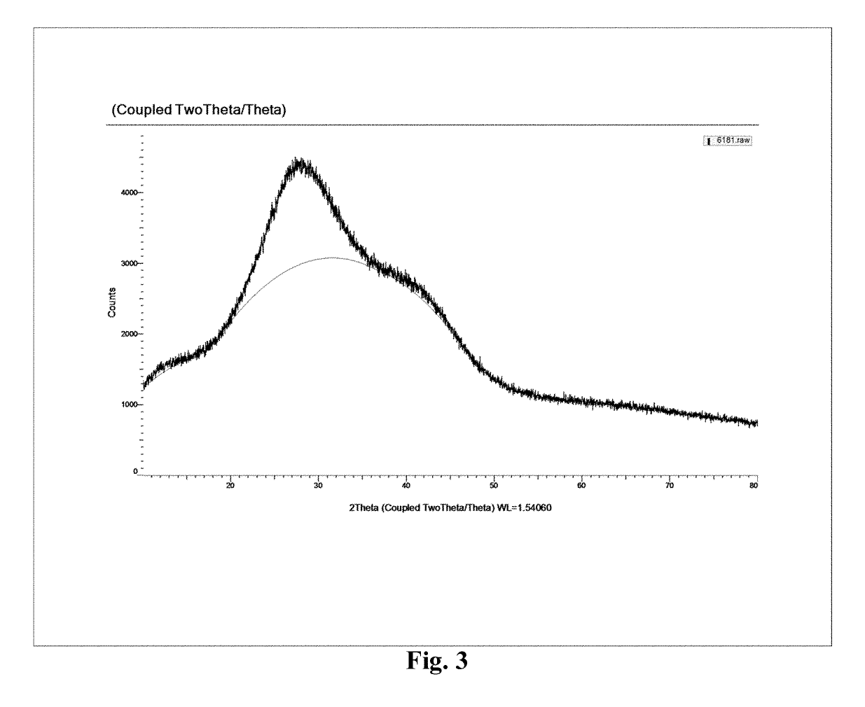

FIG. 3 shows an x-ray diffraction (“XRD”) chart of an exemplary SC nanocomposite. The XRD chart of the SC nanocomposite has diffraction peaks appearing at two theta values of approximately 2°, 27.75°, and 41°. The XRD chart indicates a substantially amorphous structure.

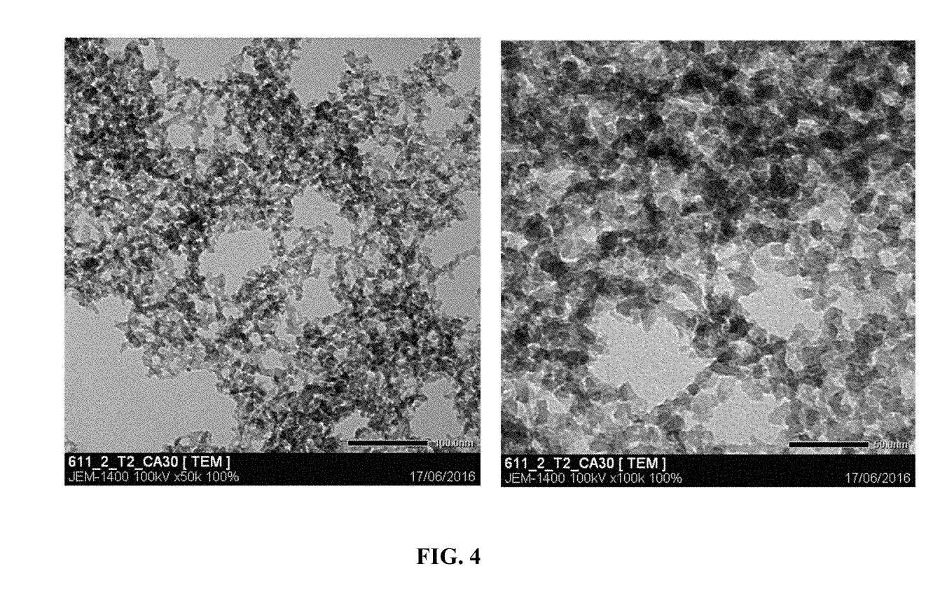

FIG. 4 shows transmission electron microscope (“TEM”) images of an exemplary SC nanocomposite. These primary particles tend to combine into hollow rings and partially show the structure of an aerogel. In a large portion of water, these rings tend to broken into individual particles and surrounding the media.

### EXAMPLES

### Example 1

In an exemplary embodiment, approximately one (1) g of the above described nano silica was mixed with approximately five (5) g of HP® deskjet® 1000 (HP is a registered trademark of Hewlett-Packard Development Company, L.P. HPQ Holdings, LLC of Houston Tex.. Deskjet is a registered trademarks of Hewlett-Packard Company Corporation of Palo Alto Calif.) black ink marked as 61. Just simply by hand shaking, a uniform black solution was achieved and marked as 61_silica 6181. The black ink 61_silica 6181 was fed into 61 cartridge ink and ready for printing with HP Deskjet 1000 printer. After few seconds, the printed pattern was soaked in water. No color running was detected. Repeating the same example with original ink 61, color running was detected. It confirmed that the nano silica 6181 effectively worked as an additive capable or rendering commercial ink 61 substantially waterfast.

### Example 2

In another exemplary embodiment, approximately 100 g of fine sand, approximately 100 g of Portland cement and approximately 500 g of tape water were mixed with approximately 100 g nano silica 6181. The mixture was coated by a coating tool on a brick substrate and let naturally dried out under natural sun light for approximately 24 hours. The specimen showed good dryness and firm surface. Repeat the above example except not adding the exemplary nano silica. As a result, it took approximately 72 hours to achieve a complete dryness. So it is confirmed that the nano silica 6181 can act as fast dry agent and water fast for cement.

Certain exemplary embodiments can be compared to a surface modified carbon black (“CB”). The surface modified CB can be well dispersed in aqueous solvent. In the following exemplary embodiment, the surface modified carbon black is blended with latex emulsion from rubber tree, nano filler comprising silica nano gel, and sulfur vulcanizer to compound a rubber tire. The method proved to be relatively energy efficient and simple and a good quality blending of these components can be achieved within a few minutes using a simple rotary mill having a rotational speed of approximately 50 revolutions per minute (“rpm”).

### Example 3

Preparation of surface modified carbon black. This example illustrates another method for the preparation of a carbon black product of an exemplary embodiment. In this example, the acid for the diazotization reaction comes from the amine forming the diazonium salt, sulfanilic acid. As a result, no additional acid was required. A carbon black (approximately 10 g) with a Cetyltrimethylammonium Bromide (“CTAB”) surface area of approximately 350 m2/g and a dibutyl phthalate absorption number (“DBPA”) of approximately 120 ml/100 g was added to a boiling solution of approximately 2.12 g sulfanilic acid in approximately 90 g of water. A solution of approximately 1.04 g of NaNO₂ in approximately 10 g water was added slowly. 4-Sulfobenzene diazonium hydroxide inner salt was formed in situ, which reacted with the carbon black. After stirring for approximately 20 minutes, the resulting dispersion was dried in an oven at approximately 120° C. A sample of the product that had been subjected to Soxhlet extraction overnight with ethanol contained approximately 3.16% sulfur, compared to approximately 0.5% sulfur for the untreated carbon black. Therefore, the carbon black product had approximately 0.83 mmol/g of attached p-C₆H₄SO₃ — groups.

Next, the above described surface modified carbon black approximately 50 g (approximately 20% solid) was added into approximately 166 g of rubber tree latex (approximately 60% solid), approximately 10 g of sulfur vulcanizer and hand shaken in a few second. The mixture was coated on aluminum substrate and then baked in an oven at approximately 200° C. for approximately 2 hours. It resulted in a water repellent and cross-linked product.

Certain exemplary embodiments provide a durability enhancing nano additive comprising a silica/acid composite. The silica/acid can be in a composite in a wet dispersion. The silica/acid composite can have:

an average particle size in the range between approximately 5 nanometers and 10 nanometers; specific surface area is in the range 443 m²/g and greater; and

an opaque or translucent white appearance.

Durability of the article comprising the silica/acid composite can be improved in a resistance to at least one of cracking, wear, or a resistance to solubility in a solvent as compared to said article without said silica/acid composite. The silica/acid composite can comprise at least one functional group selected from —OH, —SH, —NO₂, where R₁ and R₂ are selected from one of the following: H, alkyl, aryl, alkylene, arylene with or without substituent groups.

The article can have improved toughness as compared to the article without the silica/acid composite. The article can have improved wear resistance as compared to the article without the silica/acid composite. The article can have improved chemical stability against dissolution via a solvent as compared to the article without the silica/acid composite.

The article can be a product of a rubber compounding process; and/or the silica/acid composite is combined with an emulsion polymer, surface modified carbon and subjected to curer. The emulsion polymer can be latex from rubber tree. The rubber compounding process can produce rubber wheels or tires for transportation.

The article can be a waterfast printing ink. The printing ink can be inkjet printing ink, gravure printing ink, offset printing ink, and/or chemical process toner etc. The article can be a smearfast printing ink. The article can be a waterfast and smearfast paint. The article can comprise cement. The article can comprise polymers, ceramics, cement, metals, and/or wood, etc. The article can comprise emulsion polymers, thermoplastics, thermoset, proton transporting polymer, and/or cellulose, etc. The article can be used in a vehicle, building, and/or printing system, etc.

The article can be a charge captive material in a supercapacitor. The article can be a charge captive material in an energy storage system.

Certain exemplary embodiments provide a method, which can comprise mixing rice husks with a specific acid to form a SC nanocomposite, the specific acid a multifunctional carboxylic acid and sulfonic acid having functional group —OH, —SH, —NR₁R₂, —NO₂, where R₁ and R₂ are selected from one of the following: H, alkyl, aryl, alkylene, arylene with or without substituent groups. In certain exemplary embodiments, the rice husks were grown in Vietnam's Mekong River delta.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.

a—at least one.

activity—an action, act, step, and/or process or portion thereof

and/or—either in conjunction with or in alternative to.

apparatus—an appliance or device for a particular purpose.

article—a particular item or object.

associate—to join, connect together, and/or relate.

average—a number expressing a central or typical value in a set of data, in particular the mean, which is calculated by dividing the sum of the values in the set by their number.

building—a structure with a roof and walls, such as a house, school, store, or factory.

can—is capable of, in at least some embodiments.

cause—to produce an effect.

cellulose—an insoluble substance that is the main constituent of plant cell walls and of vegetable fibers such as cotton.

cement—a powdery substance made with calcined lime and clay.

ceramic—a material made of clay and hardened by heat.

charge accumulative material—a substance that is able to store an electrical potential difference between a first portion of the substance and the second portion of the substance.

chemical process toner—a black or colored powder made via at least one human controlled chemical reaction and used in xerographic copying processes.

chemical stability—when a system is in substantial chemical equilibrium with its environment.

comprising—including but not limited to.

configure—to make suitable or fit for a specific use or situation.

constructed to—made to and/or designed to.

convert—to transform, adapt, and/or change.

crack—to break without a complete separation of the parts.

create—to bring into being.

curer—to vulcanize (rubber).

define—to establish the outline, form, or structure of

device—a machine, manufacture, and/or collection thereof.

dissolution—a process by which two substances form a solution.

durability—an ability to withstand wear, pressure, or damage.

emulsion polymer—a type of a radical polymer (i.e., a polymer formed via the successive addition of free radical building blocks) produced via an emulsion incorporating water, monomer, and surfactant.

energy storage system—one or more components capable of acting as a repository for electrical energy.

functional group—a group of atoms responsible for the characteristic reactions of a particular compound.

generate—to create, produce, give rise to, and/or bring into existence.

gravure printing ink—a colored fluid with a very low viscosity that allows the ink to be drawn into engraved cells in a gravure cylinder then transferred onto a substrate.

inkjet printing ink—a colored fluid that is used in an inkjet printer that.

latex—a milky fluid from a plant that is the source of rubber.

may—is allowed and/or permitted to, in at least some embodiments.

metal—a solid material that is typically hard, shiny, malleable, fusible, and ductile, with good electrical and thermal conductivity (e.g., iron, gold, silver, copper, and aluminum, and alloys such as brass and steel).

method—a process, procedure, and/or collection of related activities for accomplishing something.

mix—to combine two or more substances.

multifunctional carboxylic acid—an acid comprising a carboxyl functional group, e.g., oxalic acid, tartaric acid, and citric acid.

offset printing ink—a colored fluid that is used in a system that transfers an image from a plate to a rubber blanket, then to a printing surface.

opaque—substantially impervious to light transmission.

particle size—a largest dimension of a solid minute portion of matter.

plurality—the state of being plural and/or more than one.

polymer—a substance that has a molecular structure consisting primarily or entirely of a large number of similar units bonded together,

predetermined—established in advance.

printing—the production of books, newspapers, or other printed material.

provide—to furnish, supply, give, and/or make available.

receive—to get as a signal, take, acquire, and/or obtain.

resistance—an ability not to be affected adversely by something.

rice husk—a hard protecting coverings of grains of rice.

rubber compounding—a process that molds a tough elastic polymeric substance made from the latex of a tropical plant or synthetically.

rubber tires—a ring-shaped vehicle component comprising rubber that covers the wheel's rim to protect it and enable better vehicle performance.

rubber tree—a tree that produces the latex from which rubber is manufactured.

SC nanocomposite—a silica/acid composite.

select—to make a choice or selection from alternatives.

set—a related plurality.

silica/acid composite—a substance comprising a silica core and having a specific acidic shell. The substance having a X-ray diffraction chart with diffraction peaks appearing at approximately two theta=20°, 27.75°, 41°.

smearfast printing ink—a colored fluid that is used in a printer that does not run or easily degrade when contacted by something after application.

specific acid—an acid selected for a specific function.

solvent—a substance that is able to dissolve other substances.

substantially—to a great extent or degree.

sulfonic acid—an organic acid containing the group —SO2OH.

supercapacitor—a high-capacity electrochemical capacitor with capacitance values much higher than other capacitors (but lower voltage limits) that bridge a gap between electrolytic capacitors and rechargeable batteries. Supercapacitors utilize use electrostatic double-layer capacitance or electrochemical pseudocapacitance. Supercapacitors have a range of capacitances between approximately 0.001 F and approximately 6,000 F. Supercapacitors have cell voltages ranging between approximately 1.4 volts and approximately 125 volts.

surface modified carbon—carbon black that has been chemically modified with specific functional groups. Cab-o-jet 200 and Cab-o-jet 300 are examples of surface modified carbon black,

system—a collection of mechanisms, devices, machines, articles of manufacture, processes, data, and/or instructions, the collection designed to perform one or more specific functions.

thermoplastic—a substance (especially synthetic resins) that becomes plastic on heating and hardens on cooling and can be repetitively subjected to such processes.

thermoset—synthetic plastic materials that strengthen while being heated, but cannot be successfully remolded or reheated after their initial heat-formation.

toughness—an ability of a material to absorb energy and plastically deform without fracturing.

translucent—permitting light to pass through but diffusing the light so that persons, objects, etc., on an opposite side are not clearly visible.

vehicle—a system that transports people or goods such as a car, truck, or cart.

via—by way of and/or utilizing.

waterfast printing ink—a colored fluid that is used in a printer that does not run after it is applied to a surface and contacted with water.

wear—to damage by friction or use.

weight—a value indicative of importance.

wet dispersion—a system in which particles are dispersed in a continuous aqueous phase.

wood—a hard fibrous material that forms the main substance of the trunk or branches of a tree or shrub.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:

there is no requirement for the inclusion of any particular described or illustrated characteristic, function, activity, or element, any particular sequence of activities, or any particular interrelationship of elements;

no characteristic, function, activity, or element is “essential”;

any elements can be integrated, segregated, and/or duplicated;

any activity can be repeated, any activity can be performed by multiple entities, and/or any activity can be performed in multiple jurisdictions; and

any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A durability enhancing nano additive comprising:
a silica/acid composite, said silica/acid composite in a wet dispersion, said silica/acid composite having:
an average particle size in a range between approximately 5 nanometers and 10 nanometers;
a specific surface area greater than 443 m²/g;
Si content greater than 96% by weight; and
an opaque or translucent white appearance; and
wherein durability of an article comprising said silica/acid composite is improved in a resistance to at least one of cracking, wear, or a resistance to solubility in a solvent as compared to said article without said silica/acid composite.

2. The durability enhancing nano additive of claim 1, wherein:
said silica/acid composite comprises at least one functional group selected from —OH, —SH, —NR₁R₂, —NO₂, where R₁ and R₂ are selected from one of the following: H, alkyl, aryl, alkylene, arylene with or without substituent groups.

3. The durability enhancing nano additive of claim 1, wherein:
said article has improved toughness as compared to said article without said silica/acid composite.

4. The durability enhancing nano additive of claim 1, wherein:
said article has improved wear resistance as compared to said article without said silica/acid composite.

5. The durability enhancing nano additive of claim 1, wherein:
said article has improved chemical stability against dissolution via a solvent as compared to said article without said silica/acid composite.

6. The durability enhancing nano additive of claim 1, wherein:
said article is a product of a rubber compounding process; and
said silica/acid composite is combined with an emulsion polymer, surface modified carbon and subjected to curer.

7. The durability enhancing nano additive of claim 1, wherein:
said article is a product of a rubber compounding process;
said silica/acid composite is combined with an emulsion polymer, surface modified carbon and subjected to curer; and
said emulsion polymer is latex from rubber tree.

8. The durability enhancing nano additive of claim 1, wherein:
said article is a product of a rubber compounding process;
said silica/acid composite is combined with an emulsion polymer, surface modified carbon and curer;
said emulsion polymer is latex from rubber tree; and
said rubber compounding process produces rubber wheels or tires for transportation.

9. The durability enhancing nano additive of claim 1, wherein:
said article is a waterfast printing ink; and
said printing ink is either inkjet printing ink, gravure printing ink, offset printing ink, or chemical process toner.

10. The durability enhancing nano additive of claim 1, wherein:
said article is a smearfast printing ink.

11. The durability enhancing nano additive of claim 1, wherein:
said article is a waterfast and smearfast paint.

12. The durability enhancing nano additive of claim 1, wherein:
said article comprises cement.

13. The durability enhancing nano additive of claim 1, wherein:
said article comprises polymers, ceramics, cement, metals, or wood.

14. The durability enhancing nano additive of claim 1, wherein:
said article comprises emulsion polymers, thermoplastics, thermoset, or cellulose, proton transporting polymer.

15. The durability enhancing nano additive of claim 1, wherein:
said article is used in a vehicle, building, or printing system.

16. The durability enhancing nano additive of claim 1, wherein:
said article is a charge accumulative material in a super capacitor.

17. The durability enhancing nano additive of claim 1, wherein:
said article is a charge accumulative material in an energy storage system.

18. The durability enhancing nano additive of claim 1, wherein:
said silica/acid composite comprises greater than approximately 96% by weight of silica.

19. A method comprising:
mixing rice husks with a specific acid to form a SC nanocomposite, said specific acid a multifunctional carboxylic acid and sulfonic acid having functional group —OH, —SH, —NR₁R₂, —NO₂, where R₁ and R₂ are selected from one of the following: H, alkyl, aryl, alkylene, arylene with or without substituent groups.

20. The method of claim 16, wherein:
said rice husks were grown in Vietnam's Mekong River delta.
